(19) United States
(12) Patent Application Publication
(10) Pub. No.: US 2025/0001779 A1
(43) Pub. Date: Jan. 2, 2025

(54) SHEET-METAL STRUCTURE AND METHOD OF ASSEMBLING A SHEET-METAL STRUCTURE

(71) Applicant: KYOCERA Document Solutions Inc., Osaka (JP)

(72) Inventor: Satoshi ANDO, Osaka (JP)

(73) Assignee: KYOCERA Document Solutions Inc., Osaka (JP)

(21) Appl. No.: 18/752,901

(22) Filed: Jun. 25, 2024

(30) Foreign Application Priority Data
Jun. 28, 2023 (JP) 2023-105722

(51) Int. Cl. B41J 29/02

(52) U.S. Cl. CPC B41J 29/02

(57) ABSTRACT

A sheet-metal structure includes a pair of first sheet-metal members, a second sheet-metal member, and a positioning mechanism. The second sheet-metal member has a flat main body portion and a pair of bent portions formed by substantially perpendicularly bending opposite end parts of the main body portion. The positioning mechanism has a swaged portion projecting inward from the inner surface of the first sheet-metal plate, an opening portion extending from the bent portion to the main body portion, and a restriction portion formed at the main body portion side end of the opening portion. The distance from the bent portion to the restriction portion is smaller than the projection height of the swaged portion. With the swaged portion in contact with the restriction portion, fixing together the first sheet-metal member and the bent portion at a fixing position away from the restriction portion across a predetermined distance.

### INCORPORATION BY REFERENCE

This application is based on and claims the benefit of priority from Japanese Patent Application No. 2023-105722 filed on Jun. 28, 2023, the contents of which are hereby incorporated by reference.

### BACKGROUND

The present disclosure relates to a sheet-metal structure made by mechanically joining a plurality of sheet-metal members and to a method of assembling a sheet-metal structure.

Some conventional image forming apparatuses have a construction in which various parts and devices built in a frame structure made of sheet-metal. As a construction that permits accurate fitting of parts and devices, a frame structure is known that includes side frames arranged opposite each other and coupling frames coupling between, so as to bridge between, the side frames.

### SUMMARY

According to one aspect of the present disclosure, a sheet-metal structure includes a pair of first sheet-metal members arranged opposite each other, a second sheet-metal member, and a positioning mechanism. The second sheet-metal member has a flat main body portion and a pair of bent portions formed by substantially perpendicularly bending opposite end parts of the main body portion and fixed so as to overlap with the first sheet-metal member, the second sheet-metal member coupling between, so as to bridge between, the pair of first sheet-metal members. The positioning mechanism positions the first sheet-metal member and the second sheet-metal member relative to each other in the direction perpendicular to the first sheet-metal member. The positioning mechanism has a swaged portion projecting inward from the inner surface of the first sheet-metal plate, an opening portion extending from the bent portion to the main body portion and overlapping with the swaged portion, and a restriction portion formed at the main body portion side end of the opening portion and making contact with the swaged portion. The distance from the bent portion to the restriction portion is smaller than the projection height of the swaged portion, and with the swaged portion in contact with the restriction portion, the bent portion deforms in the direction toward the first sheet-metal member to make contact with the first sheet-metal member, thereby fixing together the first sheet-metal member and the bent portion at a fixing position away from the restriction portion across a predetermined distance.

### BRIEF DESCRIPTION OF THE DRAWINGS

FIG. 1 is a schematic sectional view of an image forming apparatus including a main body frame according to one embodiment of the present disclosure.

FIG. 2 is a perspective view of the main body frame.

FIG. 3 is a side view, as seen from inside a side frame, around a positioning mechanism between the side frame and a first coupling frame.

FIG. 4 is a plan view, as seen from above, around the positioning mechanism.

FIG. 5 is a side view, as seen from a second coupling frame side, around the positioning mechanism.

FIG. 6 is a perpendicular sectional view of the positioning mechanism.

FIG. 7 is a horizontal sectional view of the positioning mechanism.

FIG. 8 is a side view, as seen from the second coupling frame side, around the positioning mechanism, showing how the side frame and a bent portion are fixed together.

### DETAILED DESCRIPTION

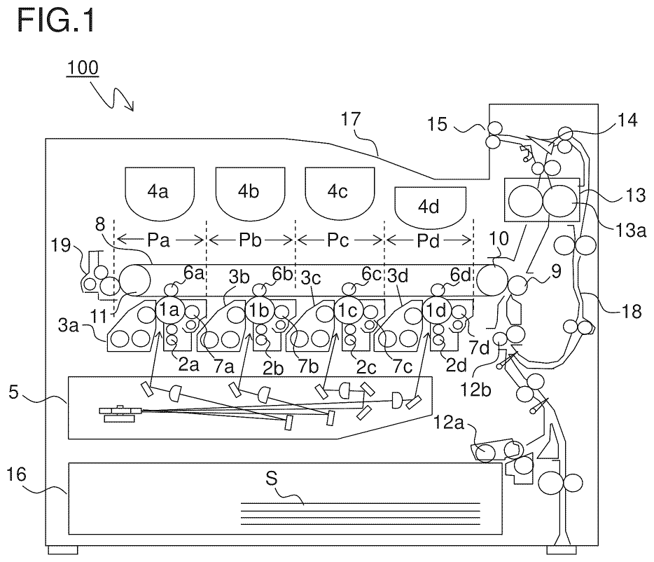

Hereinafter, an embodiment of the present disclosure will be described with reference to the drawings. FIG. 1 is a schematic diagram showing the construction of an image forming apparatus 100 including a main body frame 101 according to one embodiment of the present disclosure.

The image forming apparatus 100 shown in FIG. 1 is what is called a tandem-type color printer and has a configuration as follows. In a main body of the image forming apparatus 100, four image forming portions Pa, Pb, Pc, and Pd are arranged in this order from upstream (left side in FIG. 1) in the conveyance direction. The image forming portions Pa to Pd are provided so as to correspond to images of four different colors (yellow, cyan, magenta, and black) and sequentially form magenta, cyan, yellow, and black images, each through the processes of electrostatic charging, exposure to light, image development, and image transfer.

In the image forming portions Pa to Pd are arranged photosensitive drums 1a, 1b, 1c, and 1d, which carry visible images (toner images) of the different colors. An intermediate transfer belt 8 that rotates counterclockwise in FIG. 1 is provided adjacent to the image forming portions Pa to Pd. The toner images formed on the photosensitive drums 1a to 1d are transferred sequentially to the intermediate transfer belt 8 which moves while in contact with the photosensitive drums 1a to 1d, and are then, at a secondary transfer roller 9, transferred all at once to a sheet S as an example of a recording medium.

The sheet S to which the toner images are to be transferred is stored inside a sheet cassette 16 arranged in a bottom part of the main body of the image forming apparatus 100 and is conveyed via a sheet feed roller 12a and a pair of registration rollers 12b to the secondary transfer roller 9.

Next, the image forming process in the image forming apparatus 100 will be described. When the user enters a command to start image formation, first, a main motor (not illustrated) starts rotating the photosensitive drums 1a to 1d and charging devices 2a to 2d electrostatically charge the surfaces of the photosensitive drums 1a to 1d uniformly. Next, the exposure device 5 irradiates the surfaces of the photosensitive drums 1a to 1d with beam light (laser light) to form on them electrostatic latent images according to an image signal.

The development devices 3a to 3d are loaded with predetermined amounts of two-component developer including toner of different colors, namely yellow, cyan, magenta, and black respectively. The toner in the developer is fed from the development devices 3a to 3d to the photosensitive drums 1a to 1d and, by electrostatically adhering to them, develops the electrostatic latent images into the toner images. When the proportion of the toner in the two-component developer in the development devices 3a to 3d falls below a prescribed value, toner is supplied from toner containers 4a to 4d to the development devices 3a to 3d.

Then, primary transfer rollers 6a to 6d apply an electric field at a predetermined transfer voltage between the primary transfer rollers 6a to 6d and the photosensitive drums 1a to 1d, and thereby the yellow, cyan, magenta, and black toner images on the photosensitive drums 1a to 1d are primarily transferred to the intermediate transfer belt 8. These images of four colors are formed in a predetermined positional relationship so as to form a predetermined full-color image. After that, in preparation for the subsequent formation of new electrostatic latent images, the toner remaining on the surfaces of photosensitive drums 1a to 1d is removed by cleaning devices 7a to 7d.

As the driving roller 10 is rotated by a belt driving motor (not illustrated), the intermediate transfer belt 8 starts rotating counterclockwise; then the sheet S is conveyed with predetermined timing from the pair of registration rollers 12b to the secondary transfer roller 9 provided adjacent to the intermediate transfer belt 8 and the full-color image is transferred to the sheet S. The sheet S having the toner images transferred to it is conveyed to a fixing portion 13. The toner remaining on the surfaces of the intermediate transfer belt 8 is removed by the belt cleaning unit 19.

The sheet S conveyed to the fixing portion 13 is heated and pressed by a pair of fixing rollers 13a; thus the toner images are fixed to the surface of the sheet S and the predetermined full-color image is formed. The sheet S with the full-color image formed on it then has its conveyance direction switched by a branching portion 14 that branches into a plurality of directions, so as to be discharged as it is (or after being diverted to a duplex conveyance passage 18 to have images printed on both sides) to a discharge tray 17 by a pair of discharge rollers 15.

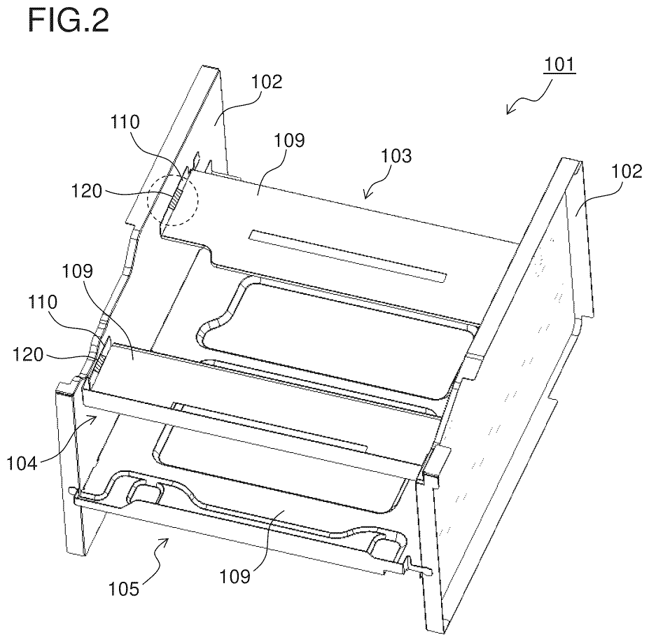

FIG. 2 is a perspective view of the main body frame 101 of the image forming apparatus 100. The main body frame 101 has a pair of side frames 102, a first coupling frame 103, a second coupling frame 104, and a third coupling frame 105.

The side frames 102 are sheet-metal members (first sheet-metal members) arranged opposite each other at the front side (at the near side of the plane of FIG. 1) and at the rear side (at the far side of the plane of FIG. 1) of the image forming apparatus 100. The first, second, and third coupling frames 103, 104, and 105 are sheet-metal members (second sheet-metal members) that each couple between, so as to bridge between, the pair of side frames 102.

The first to third coupling frames 103 to 105 have flat main body portions 109 and pairs of bent portions 110 formed by substantially perpendicularly bending opposite end parts of the main body portions 109 in the longitudinal direction. In FIG. 2, only the bent portions 110 at one end side (left side in FIG. 2) of the first and second coupling frames 103 and 104 are shown. The bent portions 110 of the third coupling frame 105 are formed by bending it downward, and are therefore not shown in FIG. 2.

The bent portions 110 of each the first to third coupling frames 103 to 105 are fixed to the inner surfaces of the pair of side frames 102, so that the first to third coupling frames 103 to 105 couple between, so as to bridge between, the pair of side frames 102.

At the coupling parts between the side frames 102 and the first to third coupling frames 103 to 105 are provided positioning mechanisms 120. The positioning mechanisms 120 position the first to third coupling frames 103 to 105 in the longitudinal direction (direction perpendicular to the side frames 102).

The positioning of the first to third coupling frames 103 to 105 with respect to the surface direction of the side frames 102 is achieved by fitting positioning projections formed on the side frames 102 into positioning holes (none is illustrated) formed in the bent portions 110.

Next, the structure of the positioning mechanisms 120 will be described in detail. While the positioning mechanism 120 between the side frame 102 and the first coupling frame 103 at its one end side (left side in FIG. 2) will be described below, the positioning mechanism 120 between the side frame 102 and the first coupling frame 103 at its other end side (right side in FIG. 2) and the positioning mechanisms 120 between the side frames 102 and the second and third coupling frames 104 and 105 have quite the same structure.

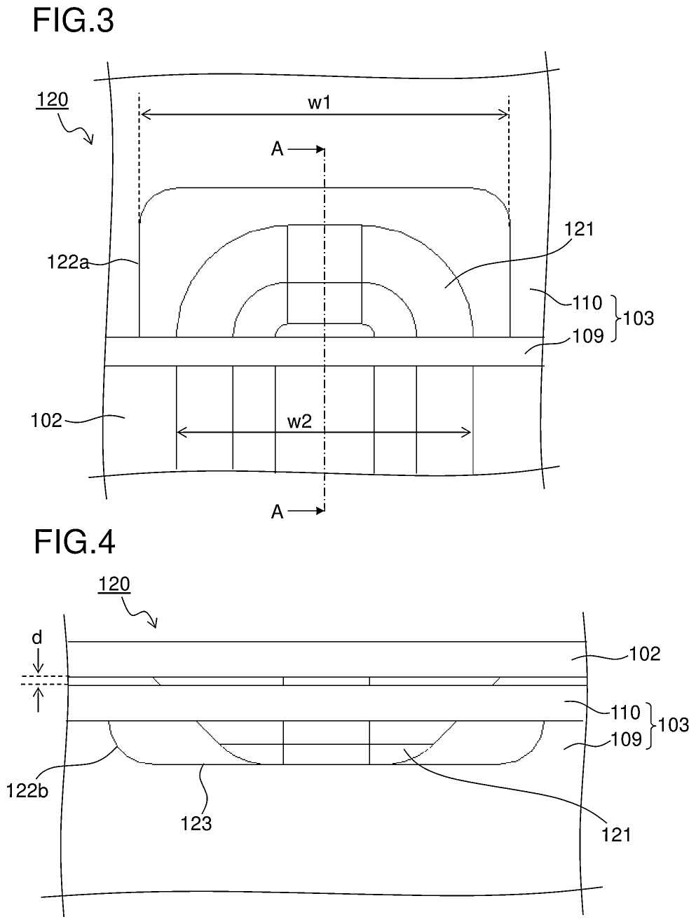

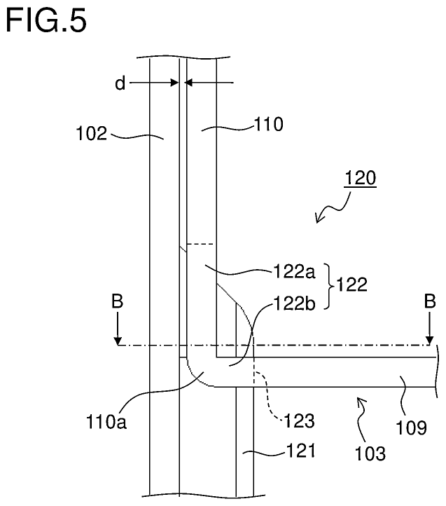

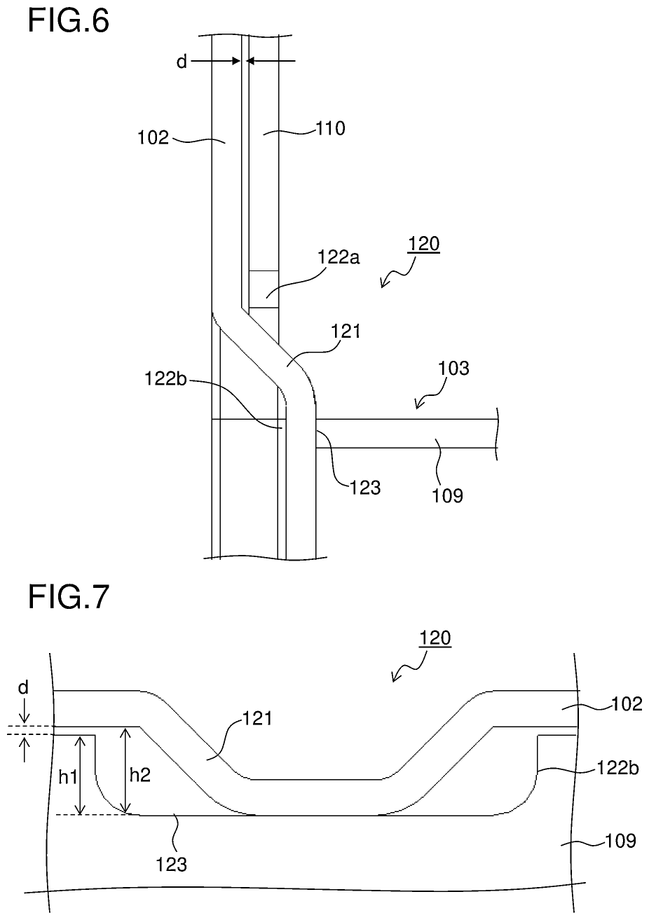

FIG. 3 is a side view, as seen from inside the side frame 102, around the positioning mechanism 120 (inside the broken-line circle in FIG. 2) between the side frame 102 and the first coupling frame 103. FIG. 4 is a plan view, as seen from above, around the positioning mechanism 120. FIG. 5 is a side view, as seen from the second coupling frame 104 side (from the lower left direction in FIG. 2), around the positioning mechanism 120. FIGS. 6 and 7 are a perpendicular sectional view (sectional view along arrow AA in FIG. 3) and a horizontal sectional view (sectional view along arrow BB in FIG. 5), respectively, of the positioning mechanism 120. FIGS. 3 to 7 show a state where the side frame 102 and the first coupling frame 103 are positioned but not fixed relative to each other.

As shown in FIGS. 3 to 7, the positioning mechanism 120 has a swaged portion 121, an opening portion 122, and a restriction portion 123. The swaged portion 121 is, as seen in a side view, in a trapezoidal shape projecting inward from the inner surface of the side frame 102. The swaged portion 121 is formed by swaging the side frame 102.

The opening portion 122 extends from the main body portion 109 of the first coupling frame 103 to the bent portion 110 beyond a bent portion 110a. The opening portion 122 is arranged so as to overlap with the swaged portion 121. The opening portion 122 has a first region 122a formed in the main body portion 109 and a second region 122b formed in the bent portion 110. The restriction portion 123 is formed at the main body portion 109 side end (in the first region 122a) of the opening portion 122.

As shown in FIG. 3, the opening width w1 of the opening portion 122 is larger than the width w2 of the swaged portion 121. Thus, when the opening portion 122 is arranged so as to overlap with the swaged portion 121, the circumferential edge of the opening portion 122 (second region 122b) does not make contact with the swaged portion 121.

As shown in FIG. 7, the depth hl of the first region 122a in the opening portion 122 (i.e., the distance from the bent portion 110 to the restriction portion 123) is smaller than the height h2 of the swaged portion 121. Thus, when the opening portion 122 is arranged so as to overlap with the swaged portion 121, the restriction portion 123 makes contact with the swaged portion 121. As shown in FIGS. 4 to 7, between the side frame 102 and the bent portion 110, a gap d corresponding to the difference h2−h1 between h2 and h1 is formed.

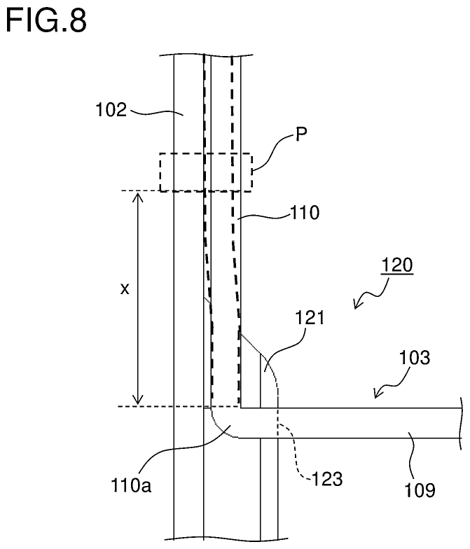

FIG. 8 is a side view showing how the side frame 102 and the bent portion 110 are fixed together. As shown in FIG. 8, when the side frame 102 and the bent portion 110 are fixed together at a fixing position P above the positioning mechanism 120, the bent portion 110 deforms toward the side frame 102 side, with the result that the gap d disappears and the side frame 102 and the bent portion 110 make surface contact with each other.

The method of fixing at the fixing position P is not particularly limited and any of conventionally known methods such as screw fastening, spot welding, and swage fastening can be used. A preferred method of swage fastening is TOX (registered trademark) clinching, in which two metal plates are held and compressed between a male and a female die so that the male-die-side metal plate extends outward along a groove provided around the circumference of the bottom surface of the female die, resulting in the two metal plates being fixed together.

In this embodiment, since the side frame 102 has the swaged portion 121, bringing the restriction portion 123 of the opening portion 122 into contact with the swaged portion 121 permits the first coupling frame 103 to be positioned in the longitudinal direction (direction perpendicular to the side frames 102).

With this design, when the restriction portion 123 is pressed against the side frame 102 by the pressure acting when the side frame 102 and the bent portion 110 are fixed together, the side frame 102 is less likely to deform compared to a construction in which the restriction portion 123 makes contact with the flat part of the side frame 102. It is thus possible to secure rigidity in the coupling part between the side frame 102 and the first coupling frame 103 and there is no need to provide a reinforcement member at the coupling portion. Also, when the exposure device 5, an intermediate transfer unit, and the like are mounted, there is also no need for position adjustment using adjustment members.

Owing to the gap d being formed between the side frame 102 and the bent portion 110, the angular tolerance (variation) of the bent portion 110 can be absorbed and the side frame 102 and the first coupling frame 103 can be positioned accurately. The gap d between the side frame 102 and the bent portion 110 is set as appropriately according to the size of the bent portion 110 and the amount of projection of the swaged portion 121.

If the distance between the swaged portion 121 and the fixing position P is short, the bent portion 110, when it is fixed to the side frame 102, deforms so much that it is necessary to increase the pressing force of the bent portion 110 against the side frame 102. This may lead to low working efficiency or deformation of the side frame 102.

To cope with that, in this embodiment, the fixing position P is displaced from the swaged part 121 so that the swaged portion 121 and the fixed position P are away from each other across a predetermined distance or more. Specifically, as shown in FIG. 7, it is preferable that the distance x between the swaged portion 121 and the fixing position P closest to the swaged portion 121 be a given distance or more. The distance x is set as appropriately according to the size of the bent portion 110 and the gap d between the side frame 102 and the bent portion 110.

The present disclosure is not limited to the above embodiments and can be carried out with any modifications made without departure from the spirit of the preset disclosure. For example, while the above embodiments deal with a positioning mechanism 120 between side frames 102 and first to third coupling frames 103 to 105 that constitute a main body frame 101 of an image forming apparatus 100, the present disclosure is also applicable to frames of other electronic devices other than image forming apparatuses.

What is claimed is:

1. A sheet-metal structure comprising:
a pair of first sheet-metal members arranged opposite each other;
a second sheet-metal member including a flat main body portion and a pair of bent portions formed by substantially perpendicularly bending opposite end parts of the main body portion and fixed so as to overlap with the first sheet-metal member, the second sheet-metal member coupling between, so as to bridge between, the pair of first sheet-metal members; and
a positioning mechanism that positions the first sheet-metal member and the second sheet-metal member relative to each other in a direction perpendicular to the first sheet-metal member,
wherein
the positioning mechanisms includes:
a swaged portion projecting inward from an inner surface of the first sheet-metal plate;
an opening portion extending from the bent portion to the main body portion and overlapping with the swaged portion; and
a restriction portion formed at a main body portion side end of the opening portion and making contact with the swaged portion, and
a distance from the bent portion to the restriction portion is smaller than a projection height of the swaged portion and, with the swaged portion in contact with the restriction portion, the bent portion deforms in a direction toward the first sheet-metal member to make contact with the first sheet-metal member so that the first sheet-metal member and the bent portion are fixed together at a fixing position away from the restriction portion across a predetermined distance.

2. The sheet-metal structure according to claim 1, wherein
the first sheet-metal member and the bent portion are fixed together at the fixing position by screw fastening, spot welding, or swage fastening.

3. The sheet-metal structure according to claim 1, wherein the sheet-metal structure is a main body frame of an image forming apparatus including:
as the first sheet-metal members, a pair of side frames arranged opposite each other at a predetermined interval, and
as the second sheet-metal member, one or more coupling frames that each couple between, so as to bridge between, the pair of first sheet-metal member.

4. A method of assembling a sheet-metal structure including:
a pair of first sheet-metal members arranged opposite each other; and
a second sheet-metal member including a flat main body portion and a pair of bent portions formed by substantially perpendicularly bending opposite end parts of the main body portions and fixed so as to overlap with the first sheet-metal member, the second sheet-metal member coupling between, so as to bridge between, the pair of first sheet-metal member,
wherein
the first sheet-metal member has a swaged portion projecting inward from the inner surface of the first sheet-metal plate;
the second sheet-metal member has:
an opening portion extending from the bent portion to the main body portion and overlapping with the swaged portion; and
a restriction portion formed at a main body portion side end of the opening portion and making contact with the swaged portion, and
the method comprises:
a positioning step of perpendicularly pressing the restriction portion against the swaged portion to position the second sheet-metal member with respect to the first sheet-metal member; and
a fixing step of, with the swaged portion in contact with the restriction portion, deforming the bent portion in a direction toward the first sheet-metal member to bring the first sheet-metal member and the bent portion into contact with each other so as to fix together the first sheet-metal member and the bent portion at a fixing position away from the restriction portion across a predetermined distance.
